(19) United States
(12) Patent Application Publication
(10) Pub. No.: US 2017/0206547 A1
(43) Pub. Date: Jul. 20, 2017

(54) DISPLAY FIXTURE CONFIGURATION AND MANAGEMENT SYSTEM

(71) Applicants: Samuel Arthur Vise, Toronto (CA); Ranko Dimic, Toronto (CA)

(72) Inventors: Samuel Arthur Vise, Toronto (CA); Ranko Dimic, Toronto (CA)

(21) Appl. No.: 15/369,305

(22) Filed: Dec. 5, 2016

Related U.S. Application Data
(60) Provisional application No. 62/279,982, filed on Jan. 18, 2016.

(51) Int. Cl. G06Q 30/02; H04N 5/775; G06Q 10/08; H04N 21/41; H04N 21/258; G11B 27/19; H04N 21/262

(52) U.S. Cl. CPC G06Q 30/0241; G11B 27/19; H04N 5/775; H04N 21/26258; H04N 21/4122; H04N 21/25808; G06Q 10/087

(57) ABSTRACT

Systems and methods for managing a store's advertising and product displays. A system includes at least one database of products details regarding each product's various prices, physical packaging dimensions, descriptions, and at least one image of each product. The system allows a user to configure a fixture on which products are to be displayed, including the fixture's physical dimensions. Each display fixture can then be provisioned by the user so that the identity of the products to be displayed on each display peg or shelf, along with how many of that product, is displayed. The database may also include a database of the various display fixtures used in the store along with the parts, components, and supplies for those fixtures. A method for automatically allowing monitors to self-update content is also part of the invention and may be used with smart or intelligent televisions or monitors.

### CROSS-REFERENCE TO RELATED APPLICATION

This application claims the benefit of U.S. Provisional Patent Application Ser. No. 62/279,982, filed Jan. 18, 2016, and titled “Display Fixture Configuration and Management System,” which is incorporated herein by reference in its entirety.

### FIELD OF THE INVENTION

The present invention relates to the field of managing advertising and product placement. More specifically, the present invention relates to methods, systems, and devices for managing fixtures used for displaying products at retail stores as well as for managing content to be displayed on large screen monitors at such retail stores.

### BACKGROUND OF THE INVENTION

Product placement and managing the displays where these products are shown to the public has become a much more competitive and complex matter in recent years. Nowadays, large retailers seek to manage their store displays, advertising, and product placements centrally and with a view towards profit. Gone are the days of haphazard placement of products based on the whim of the store manager or on the whim of the sales staff.

Most chain retailers with large stores spread out across the country want a planned, chain-wide approach to store displays as well as to the placement and display of products. Such an approach, ideally, would take into account stock levels of the various products on display as well as the physical needs for displaying such products. As an example, placing one product with 8-inch wide packaging next to another product with 6 inch wide packaging on a rack that is only 12 inches wide across would not be acceptable. Those setting the chain-wide display policy at the chain retailer's head office may, however, not be aware of the hands-on requirements for such displays.

In addition to the above issue, the maintenance and upkeep of the various displays and fixtures at the various stores of a chain retailer may not be adequately addressed by either the store or those at the head office. Broken shelves, replacements for missing or broken parts of fixtures (such as display stands) may be difficult to find. As well, local employees and even those at head office may not know who is responsible for finding/replacing the missing or broken parts. This leads to inefficiencies and, in many cases, unrepaired fixtures.

As a related issue, while current video displays or monitors at chain retail stores are programmed to play a number of videos in a loop, managing and changing this content can be cumbersome. Current technology uses a dedicated network-connected video box for each monitor. Each of these video boxes requires programming and the location of each monitor in the store is not taken into account when programming the content to be displayed.

Based on the above, there is therefore a need for solutions which mitigate if not overcome the shortcomings of the prior art. Such solutions should, preferably, allow users to freely configure a store's layout including placement of display stands, display shelves, and video monitors. As well, it would be preferable if more than one configuration can be entered for a store. Similarly, it would be advantageous if such solutions allow users to configure each display shelf or display stand based on a store's inventory, the product's packaging, and the shelf s physical dimensions.

### SUMMARY OF INVENTION

The present invention provides systems and methods for managing a store's advertising and product displays. A system includes at least one database of products, details regarding each product's various prices, physical packaging dimensions, descriptions, and at least one image of each product. The system allows a user to configure a fixture on which products are to be displayed, including the fixture's physical dimensions. Each display fixture can then be provisioned by the user so that the identity of the products to be displayed on each display peg or shelf, along with how many of that product, is displayed. The system also alerts the user if the provisioning is proper or not, taking into account each product's packaging dimensions. Once provisioned, each display fixture can also be placed on a display/product placement plan diagram of the store by the user. The database may also include a database of the various display fixtures used in the store along with the parts and components of those fixtures. If parts of a fixture are required, a store employee can query the database to determine which parts are required, where those parts are sourced, and how to order those parts. A method for automatically allowing monitors to self-update content is also part of the invention and may be used with smart or intelligent televisions or monitors.

In a first aspect, the present invention provides a system for managing display fixtures, the system comprising:

a display fixture configuration module for use in configuring at least one display fixture, said display fixture configuration module being used in conjunction with an inventory database;

an item entry module for use in entering data regarding at least one item for display on said at least one display fixture, said data regarding said at least one item being for storage in said inventory database;

a display fixture management module for managing said at least one display fixture, said display fixture management module being for managing supplies and parts associated with said at least one display fixture, said display fixture management module being used in conjunction with a display fixture database; and

a fixture item entry module for use in entering data regarding at least one supply or part associated with said at least one display fixture, said data regarding said at least one supply or part being for storage in said display fixture database.

In a second aspect, the present invention provides a method for controlling content to be played on a network connected smart monitor, the method comprising:

a) receiving a network address to be accessed by said smart monitor;

b) accessing a computer executable script at said network address;

c) accessing at least one video file pointed to by said script;

d) playing said at least one video file;

e) periodically accessing a server referred to by said network address to upload an identification of said at least one video file;

f) in the event said identification is determined to be incorrect by said server, receiving a new identification of at least one video file to be played;

g) repeating steps d)-f).

### BRIEF DESCRIPTION OF THE DRAWINGS

The embodiments of the present invention will now be described by reference to the following figures, in which identical reference numerals in different figures indicate identical elements and in which:

FIG. 1 is a block diagram of a system according to one aspect of the invention;

FIG. 2 is a screenshot of a user interface illustrating a display fixture to be configured;

FIG. 3 is a screenshot of a user interface for use with the display fixture configuration module;

FIG. 4 is another screenshot illustrating another view of a user interface which may be used with the display fixture configuration module;

FIG. 5 is yet another screenshot of a further view of a user interface for use with the display fixture configuration module;

FIGS. 6A-6C are screenshots of user interfaces for use with the fixture and supply management functions of the invention;

FIG. 7 is a screenshot of a user interface illustrating the supplies allocated to a display fixture;

FIGS. 8A-8E are screenshots of user interfaces for use with the fixture item entry module as well as with the fixture management module of the invention;

FIG. 9 is a block diagram used to illustrate the connections between a server and multiple users as envisioned for the present invention; and

FIG. 10 is a block diagram used to explain the functions of the smart TV aspect of the present invention.

### DETAILED DESCRIPTION OF PREFERRED EMBODIMENTS

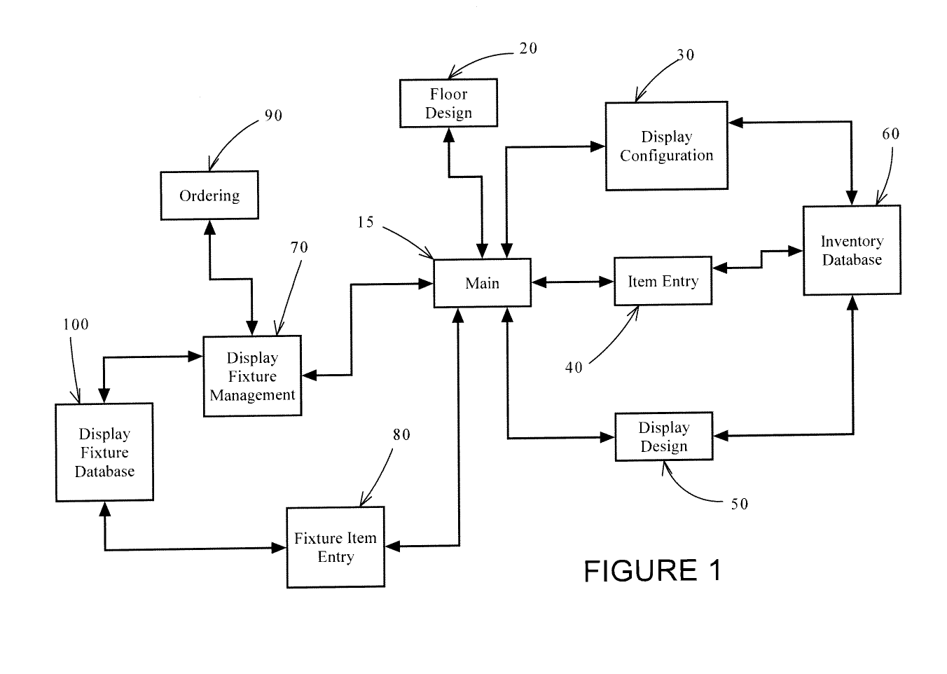

Referring to FIG. 1, a block diagram of a system according to one aspect of the invention is illustrated. A system 10 includes a main module 15, a floor design module 20, a display configuration module 30, an item entry module 40, and a display design module 50. The display configuration module 30, item entry module 40, and display design module 50 communicate with an inventory database 60. Also part of the system 10 is a display fixture management module 70, a display fixture item entry module 80, and an ordering module 90. The display fixture management module 70, display fixture entry module 80, and ordering module 90 communicate with a display fixture database 100.

In operation, a user accesses the system 10 by way of the main module 15. From the main module 15, the user can design a display plan (i.e. a planogram) for a store using the floor design module 20. The display plan or planogram would detail not just the layout of the store but also the location, type, and configuration of display fixtures throughout the store. The user can also use the display configuration module 30 to manage and/or configure a specific display fixture such as a shelf, cabinet, or display rack. The user can thus designate which products are to be placed on which display fixture, where on that display fixture, and how many of that product is to be placed on each peg and/or rack of that display fixture. Details for each product available to a store can be entered by a user by way of the item entry module 40. These details are stored for each product in the inventory database 60. While the details of the various display fixtures available to a store may be stored in the inventory database 60 or in the display fixture database 100, the user may also custom design a display fixture by way of the display design module 50. The display design module 50 allows the user to design a display fixture by designating the display fixtures height, width, and depth. Once designed, the details of the custom display fixture can be saved in one of the databases and can then be configured by way of the display configuration module 30 and can be used in the floor design module 20.

It should be noted that, to assist the user when configuring each display fixture, within the inventory database, each entry for various products may include a product's size, shape, the physical dimensions of the product's packaging, at least one image for the product, details about the product, the sale price for the product, the product cost, the regular price for the product, the product's manufacturer's suggested retail price, the product's SKU (stock keeping unit), the manufacturer for the product, as well as details regarding reordering of the product.

To manage the various display fixtures at the various stores, the display fixture management module 70 may be used. A user can use the display fixture management module 70 to determine which parts are needed whenever a display fixture requires repairs or replacement. The user can enter the details for the various parts and components for each display fixture. These entries are then saved in the display fixture database 100. It is preferred that the entry for each part or component would include an image of the display fixture that uses the part, a diagram of where the part or component fits in the display fixture, along with details on how to reorder the part or component.

It should be noted that the term “display fixture” used in this document includes display shelves, display cabinets, display racks, counter top displays, pegboard-equipped displays (including free standing displays, wall mounted displays, and counter-top displays) and any other device or item which is used to display one or more products or one or more pieces of advertising. The term may thus also include picture frames, poster frames, video monitors, television monitors, computer workstations used to display software or videos, etc.

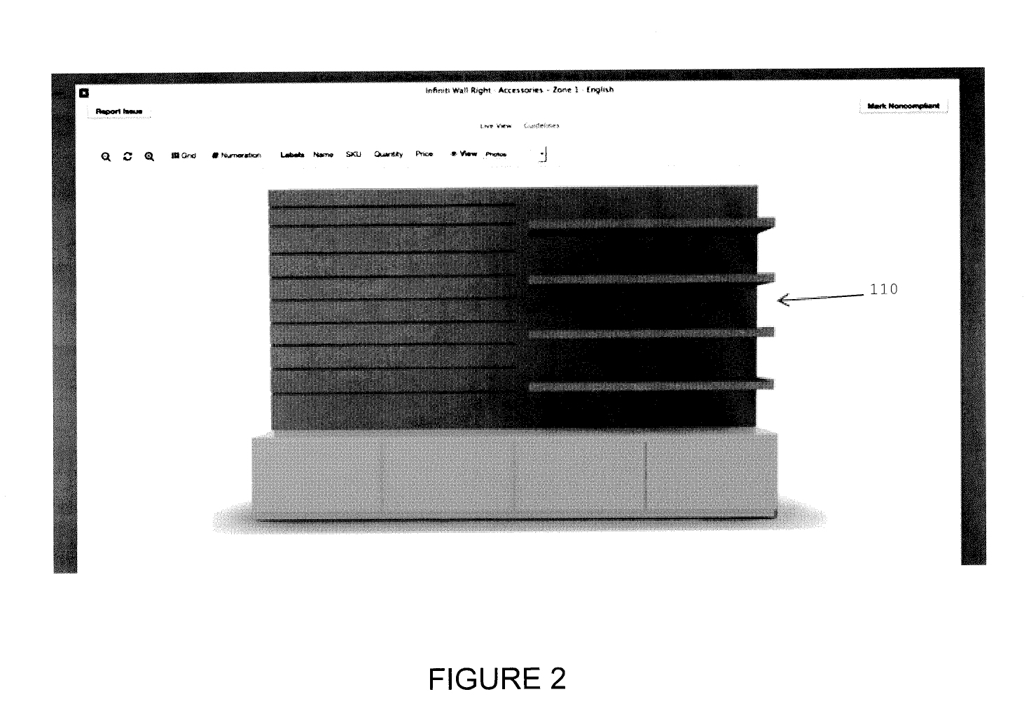

Referring to FIG. 2, a screenshot of a user interface associated with the display configuration module 30 is illustrated. As can be seen, an image of a display fixture 110 is presented. In one implementation, the display fixture 110 is a standard display fixture and its physical dimensions and image are stored in the display fixture database 110 and can be called up by the user for configuration either before or after the display fixture is placed on the storewide planogram. Once the desired display fixture has been either selected from preconfigured display fixtures in the display fixture database or created using the display design module 50, the display fixture can be configured by populating the various storage options on the display fixture (e.g. pegs, shelves).

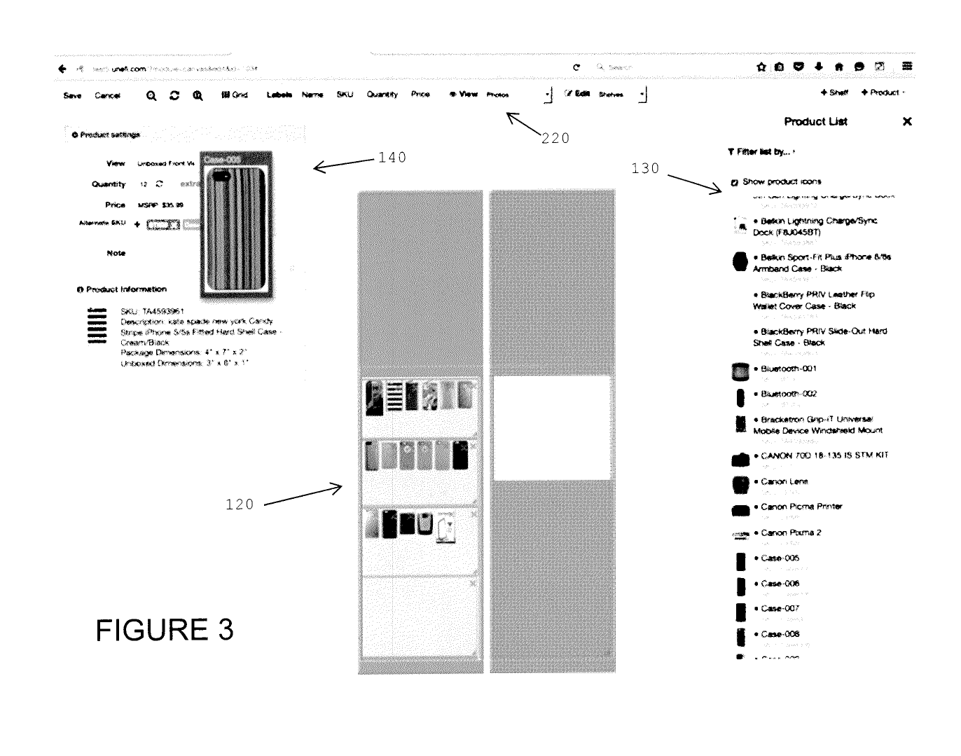

Referring to FIG. 3, a user interface for the display configuration module 50 is illustrated. As can be seen, the user interface has a section 120 for the display fixture. A product list 130 lists the various products available for placement on the display fixture. A user can click and drag an item from the product list 130 to the display fixture. Doing so will place a picture of the selected product on the relevant section of the display fixture. It should be noted that the physical size of the display fixture is known to the system along with the physical size of the product packaging and, on the user interface, all images are scaled accordingly so that relative sizes are preserved. When a product is selected from the list 130, a window 140 opens up to show the settings for that specific product. The window 140 provides details for the selected product including the view for the product's image (e.g. front view, side view, packaged view, unpackaged view) , the product's SKU, a description for the product, the product package's dimensions, a quantity of the product (i.e. how many units of the product are in inventory), and the various prices for the product (e.g. the product's MSRP, the cost for the product, the regular price for the product, and a sale price for the product). An image for the product is also displayed when the product is selected. Of course, multiple images of each product may be stored on the database based on the view of the product. A user may upload one or more images per product as desired.

It should be noted that the window 140 also has an entry for an “alternative SKU” for the selected product. This alternative SKU details a product which can be used or displayed in place of the selected product in the event there are no more units of the selected product available to the store. Alternatively, the “alternative SKU” can detail a product which can be placed behind the selected product on the display fixture's peg or shelf.

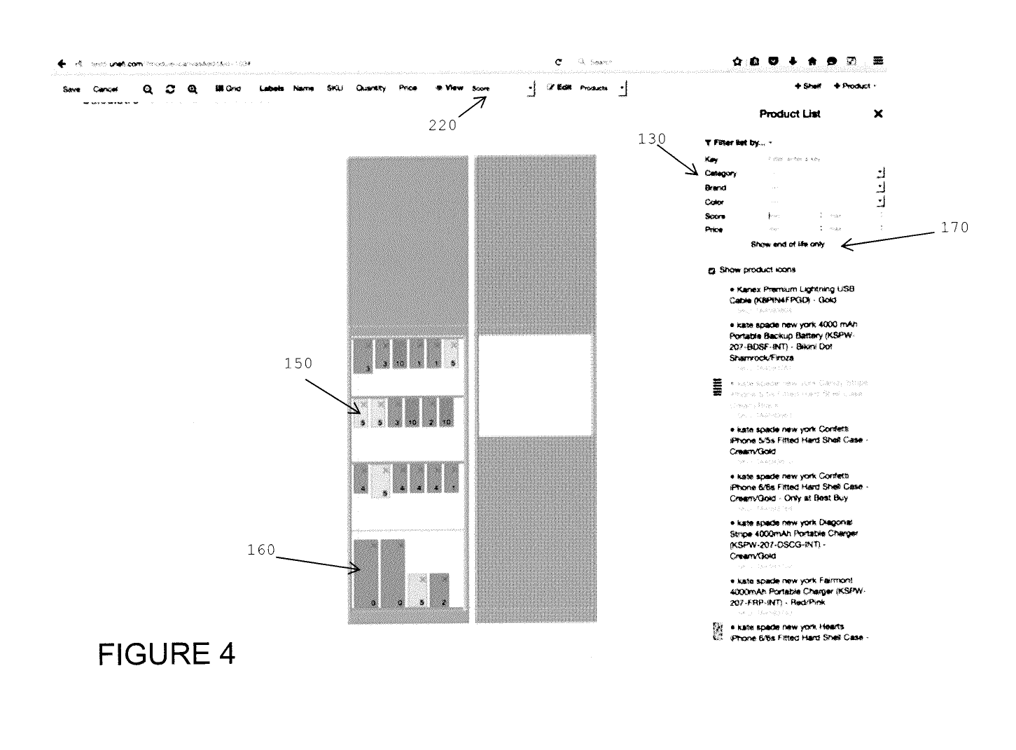

The view of the configured display fixture in FIG. 3 shows how the display fixture will look in the store. In FIG. 4, another view of the configured display fixture is illustrated. In FIG. 4, instead of the image of the product's packaging, a block which preserves the relative size of each product is used while other pieces of information are displayed on each product. In one implementation, each product is grouped by product category and each product category is illustrated by a different color. This allows the user to see how many products from each category are displayed on the display fixture. In another implementation, each product that has been selected and placed on the display fixture is identified on the product list by having the corresponding entry in the product list colored differently from products which have not been placed on the display fixture. This allows the user to quickly see which products on the list are not currently selected for the specific display fixture.

Another feature illustrated in FIG. 4 is that of scoring. A product's score may be based on the product's relative sales performance (i.e. how many of that product was sold relative to other comparable products) or on that product's profit margin. For sales performance, the system can import sales data from one or more suitable sources such as from a separate accounting database or from a user provided spreadsheet. For a profit margin based score, the product's entry in the inventory database would contain the product's per unit cost along with the product's retail price. Scoring is relative in that a product's score may be relative to other products selected and placed on the display fixture or a product's score may be relative to other products in the same category. Once scored (e.g. on a 10 point scale—other scales may, of course, be used), a product's score is illustrated on the product's box on the user interface as illustrated in FIG. 4. As an example, item 150 has a score of 5 while product 160 has a score of 0. By being able to simultaneously color code the products on the display fixture being configured and to score or rank these same products, a user can balance profitability with product exposure, product selection, and product diversity on the same display fixture.

It should be noted that the scoring feature mentioned above can also be used to color code the various products selected for the display fixture in FIG. 4. In one implementation, the scores are divided into three divisions with one division being products having a score of 10-7, a second division being products having a score of 6-3, and a third division being products with a score of 2-0. Each division is assigned a different color. By color coding the blocks for the products displayed on the display fixture, a user can quickly determine how many products of each division is to be displayed on the display fixture. Since a product's score can be determined using any number of bases (e.g. price, profit, quantity, etc., etc.), the user can thus quickly view the ramifications of the selected products based on any one of the multiple score bases. As an example, if a user wanted to see the profit distribution of the selected products on display, the products can be scored based on profitability and then color coded based on that profitability score. Thus, if green is selected as the color for most profitable products, yellow is selected for medium profitability products, and red is selected for minimal profitability products, the user can quickly view how many of each type of product is on the display fixture. Not only that, but the user can also use this feature to position products on the display fixture based on the product scores.

FIG. 4 also illustrates that each of the products placed on the display fixture can be labeled by product name, SKU, quantity, or price. Thus, instead of a product's score, the product's box on display fixture on the user interface can display that product's name, SKU, retail price (or cost price), or how many of that product is displayable on that display fixture's peg or shelf (i.e. quantity). It should be noted that, to display a product's quantity, the system uses the product's physical packaging dimensions along with the display fixture's physical dimensions to calculate how many of that product can be displayed. As an example, if a product's packaging has a depth of 5 cm and the display fixture has a usable depth of 30 cm, then only six instances of that product can be displayed on the display fixture's shelf or peg. This allows the user to determine how many of each product can be displayed on the display fixture. Thus, the user may see if 5 instances of a first product (housed in large packaging) is more suitable than 10 instances of a second product (housed in smaller packaging).

Yet another feature of the system is illustrated in FIG. 4. In the product list 130, the list can be filtered by any number of criteria including product category, brand, color, score (whether price based or quantity based), or price. Products which meet the user entered criteria are then listed on the product list 130. Another feature of this filter function is the end of life button 170. When selected, the product list 130 only lists products that have been discontinued, are on remainder, or are no longer available. This feature allows the user to quickly view which products can be displayed for a quick sale or which can be deeply discounted. It should be noted that the filter function can be used in addition to the end of life button. This, a user can not only view which products are at their end of life but these products can further be filtered based on the numerous criteria listed above.

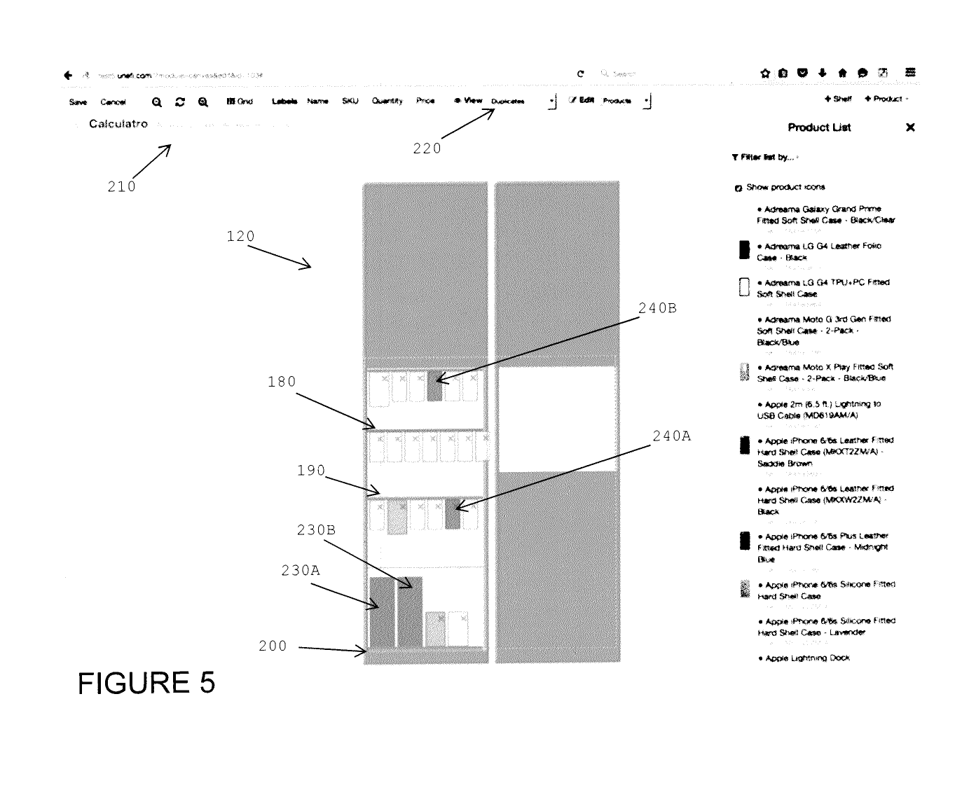

Referring to FIG. 5, another feature of the system is illustrated. To determine if a configuration of a specific display fixture is feasible or not, the configuration module visually shows the user the result of his or her choices. As can be seen, shelf 180 on the display fixture 120 has seven products. However, there is only enough space on the shelf 180 to accommodate six products. This can be seen as the seventh product is clearly outside the bounds of the display fixture. As noted above, the relative physical size of each product's packaging is retained when being placed on the display fixture. Similarly, the display fixture's physical size is retained relative to each product's packaging. This allows the user to visually see whether his or her configuration of the display fixture is feasible or not. A user merely has to drag a product from the product list 130 to a specific shelf on the display fixture 120 to place that product on the shelf. In the event a product cannot be accommodated on the display fixture (such as in the case of shelf 180), the shelf changes color to alert the user. In FIG. 5, the shelf 180 is of a different color than shelf 190 or shelf 200. As noted above, the system determines whether a user's product placement can be accommodated or not based on the physical sizes of the various products placed on the display fixture as well as the physical size of the display fixture itself.

It should be noted that shelf 200 is one where products are placed on while shelf 190 and shelf 180 are, in their real-world manifestation, equipped with pegs from which products are hung.

Also shown in FIG. 5 is one viewing choice for the products placed on the display fixture. A menu bar 210 at the top of the user interface has a choice 220 for viewing the products. In FIG. 5, the DUPLICATES choice is selected and this means that products are color coded based on their category. This shows the user which products on the display fixture are of the same category. The bottom products 230A, 230B are of one category while products 240A, 240B are of a different category as these are of a different color. Another viewing choice, shown in FIG. 3 is that of PHOTOS. In FIG. 3, the choice 220 has PHOTOS selected and, as such, the products on the display fixture are represented by their photographs instead of by simple boxes as in FIG. 5. In FIG. 4, the viewing choice selected is that of SCORE and the various products are thus illustrated with their score inside their representative boxes. Of course, regardless of the viewing choice, each product's representation retains its size relative to the other products and relative to the physical size of the display fixture. This allows the user to thus see whether a product will fit on the display fixture or not regardless of the viewing option.

In another aspect of the invention, the system includes display fixture management module 70 noted in FIG. 1. A user can create and edit entries for parts and components of display fixtures by way of the fixture item entry module 80 with entries being saved in the display fixture database 100. Parts and components can be ordered using the ordering module 90.

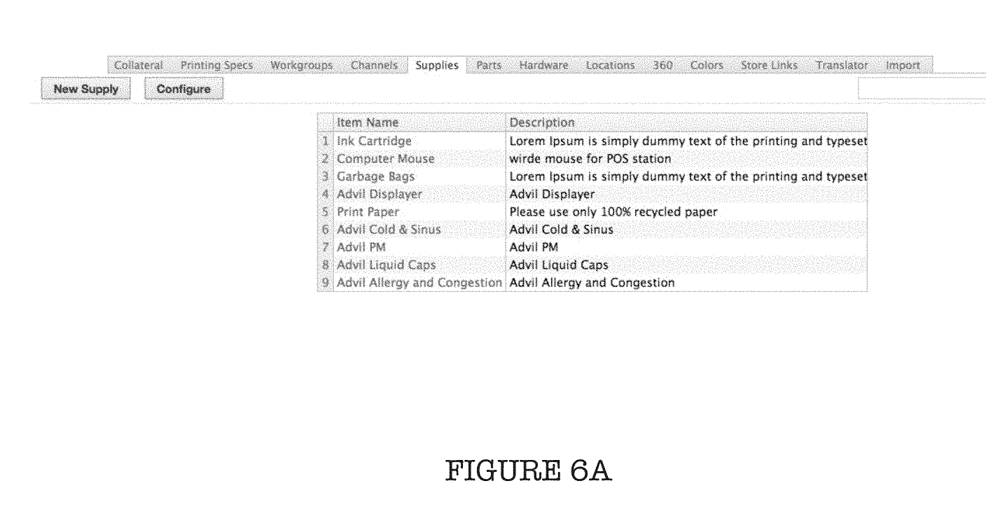

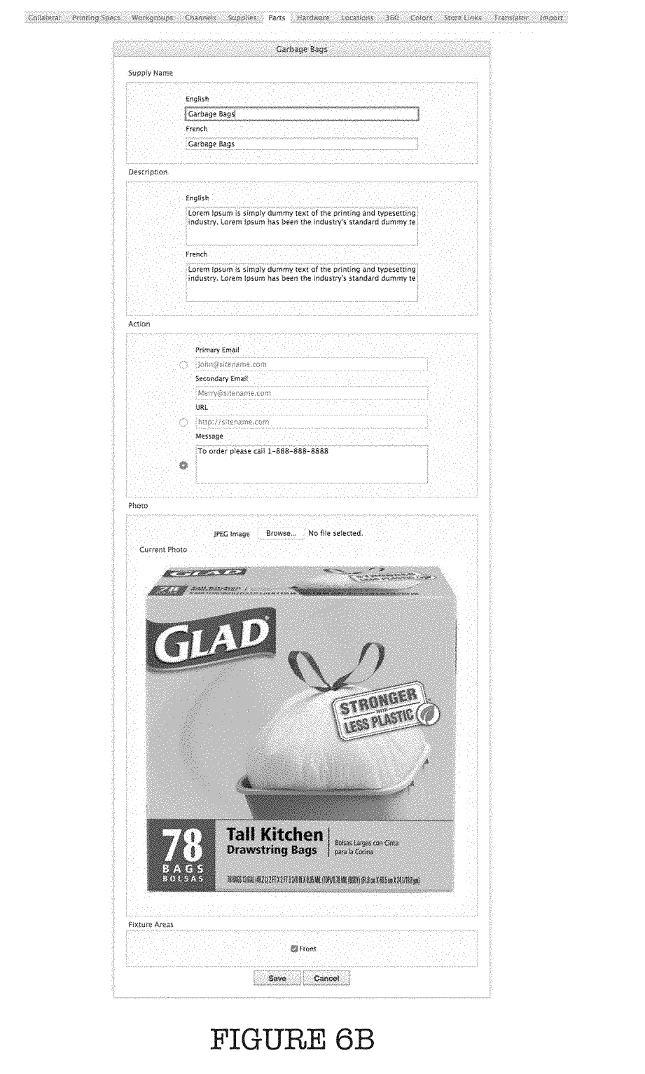

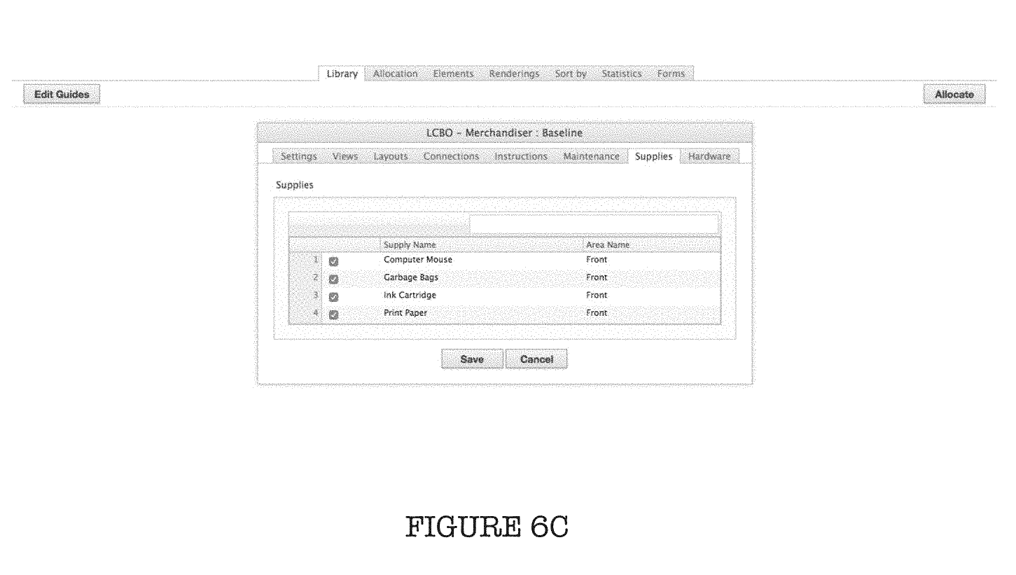

Referring to FIG. 6A, a screenshot of a user interface for the fixture item entry module 80 is illustrated. As can be seen, a user can create entries for parts, components, and supplies for use with display fixtures or, indeed, for parts, components, and supplies of any fixture. This may include parts and components, consumables (e.g. printer cartridges, paper, garbage bags), and any other supplies that may be needed by a store. Referring to FIG. 6B, once the entry has been created for the supply item, details can then be added to the entry. These details may include an image of the item, the name of the item, a description of the item, a quantity of the item usually ordered (e.g. a box of paper containing 10 reams of paper with each ream containing 200 sheets), a regular or usual supplier for the item, contact information for the supplier (e.g. telephone number, a main contact email address, an alternate contact email address, and a physical address), a website for the main supplier, and any other details which may be helpful when ordering the item. Once the details are entered and the entry has been made, each fixture can be allocated with one or more relevant items. In FIG. 6C, each fixture is allocated at least one supply. To assist in determining which item applies to which part or area of which fixture, each fixture with multiple parts of the same type are assigned numbers and letters as necessary. Thus, a cabinet fixture with three drawers would have Drawer A, Drawer B, and Drawer C, each of which may have multiple parts, components, or supplies. The cabinet fixture may have Door A and Door B and each door can be allocated a specific hinge. Similarly, blank rolls for a cash register might be kept in Drawer A of the cabinet while pens might be kept in Drawer B. These consumable supplies would thus be allocated to the cabinet fixture and to their specific location (e.g. Drawer A or Drawer B as the case may be).

Referring to FIG. 7, a user interface for the ordering module 90 is illustrated. In the example, the fixture is noted as being a side counter kiosk with multiple drawers. As can be seen, each supply item allocated to the kiosk fixture is listed along with a description of that supply item, notes regarding ordering the item, the location/area of the supply item on the fixture, as well as a blank area where the user can enter how many of each item to order. A user can thus check a box 250 to order an item. To assist the user when selecting which items to order, clicking on an item opens up a window which shows an image of the selected item along with a title and/or description of the item. Thus, before a user orders an item, he or she can confirm that it is the item they want by checking the image of the item selected.

As another aspect of the invention, the system also allows for parts and components for fixtures to be easily ordered. As with supplies, entries for each part or component can be created and each part's entry can include as much information as necessary for the proper ordering and use of the part. Each part can then be associated with a specific fixture and the location of that part is illustrated on an image of the fixture. Conditions and actions specific to the part can also be entered so that the issue with the part can be addressed. As an example, a drawer on a fixture can be designated as “STICKING” (i.e. does not slide out smoothly), “BROKEN”, “JAMMED”, or “LOOSE”. A suitable work order or request for repairs can then be generated by the system.

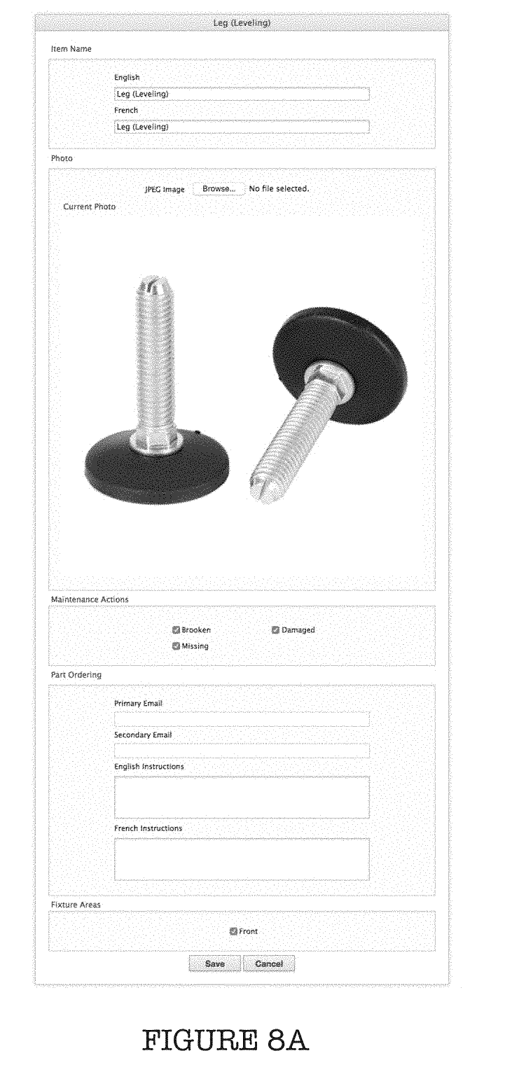

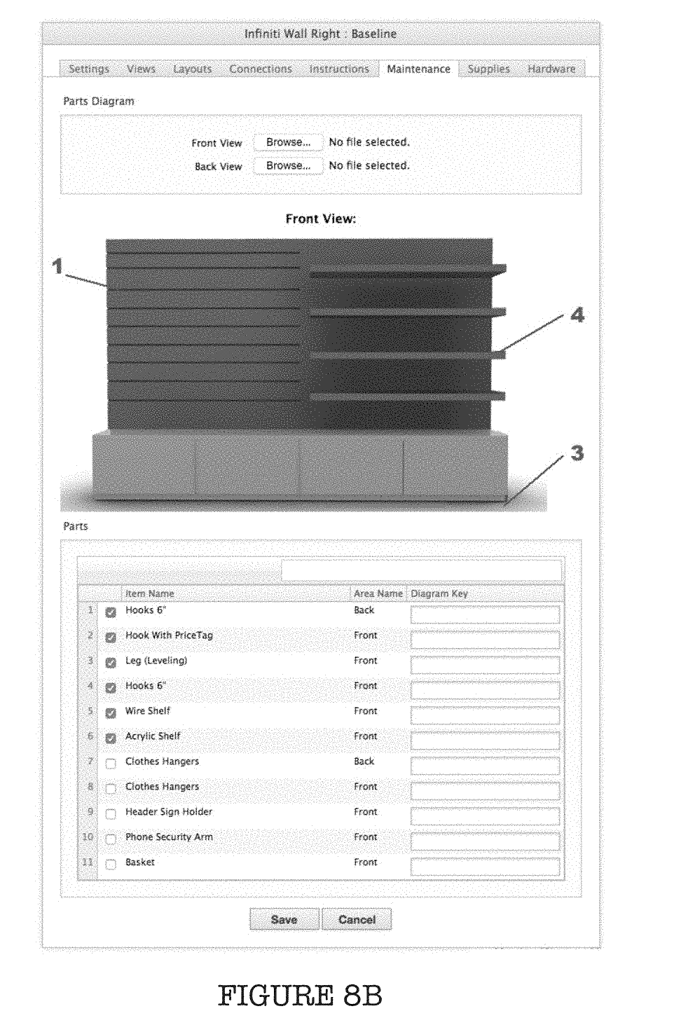

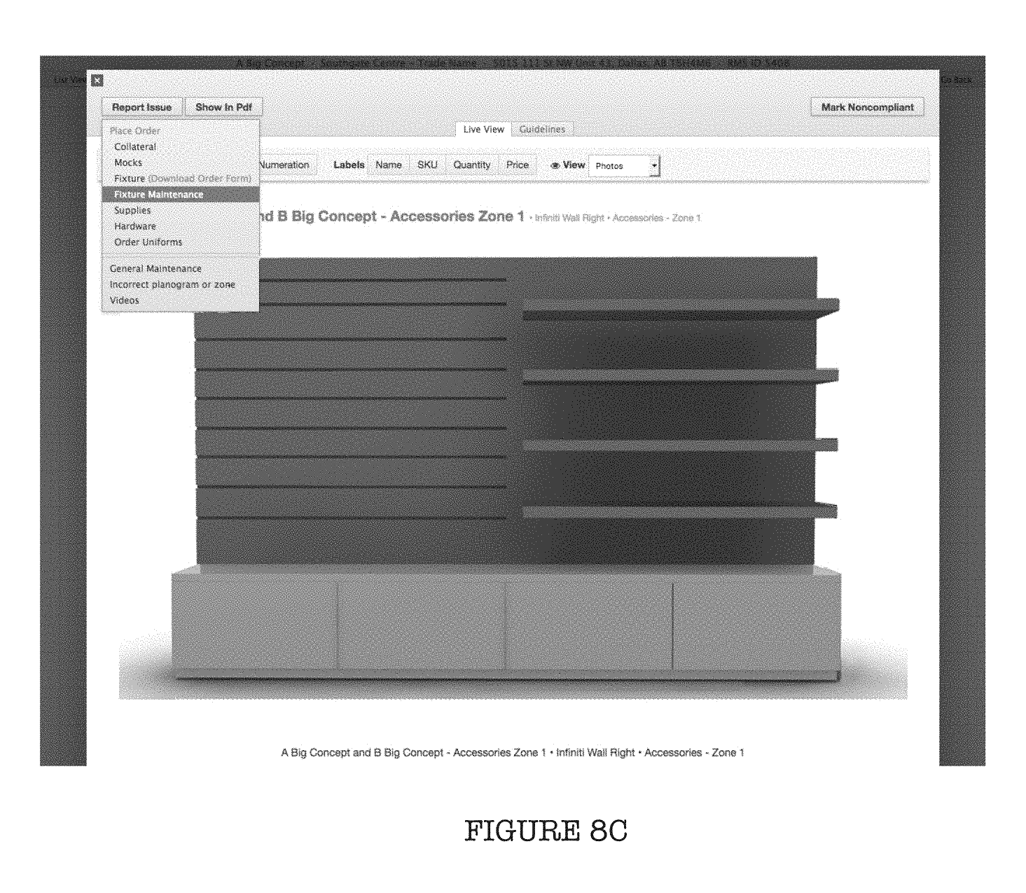

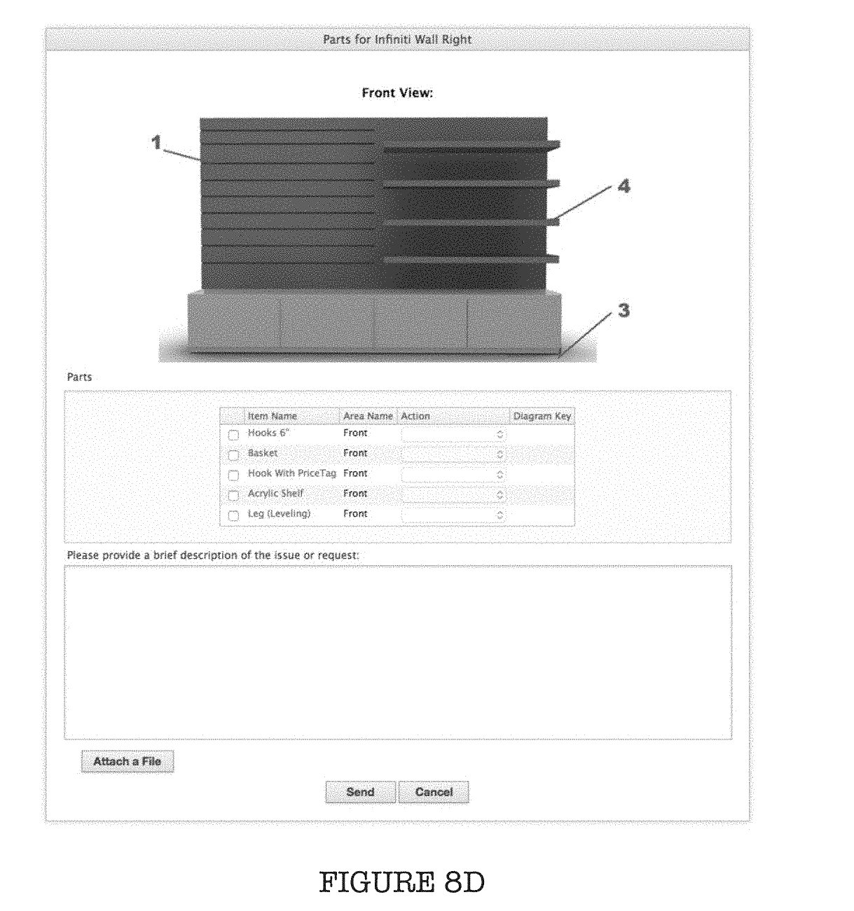

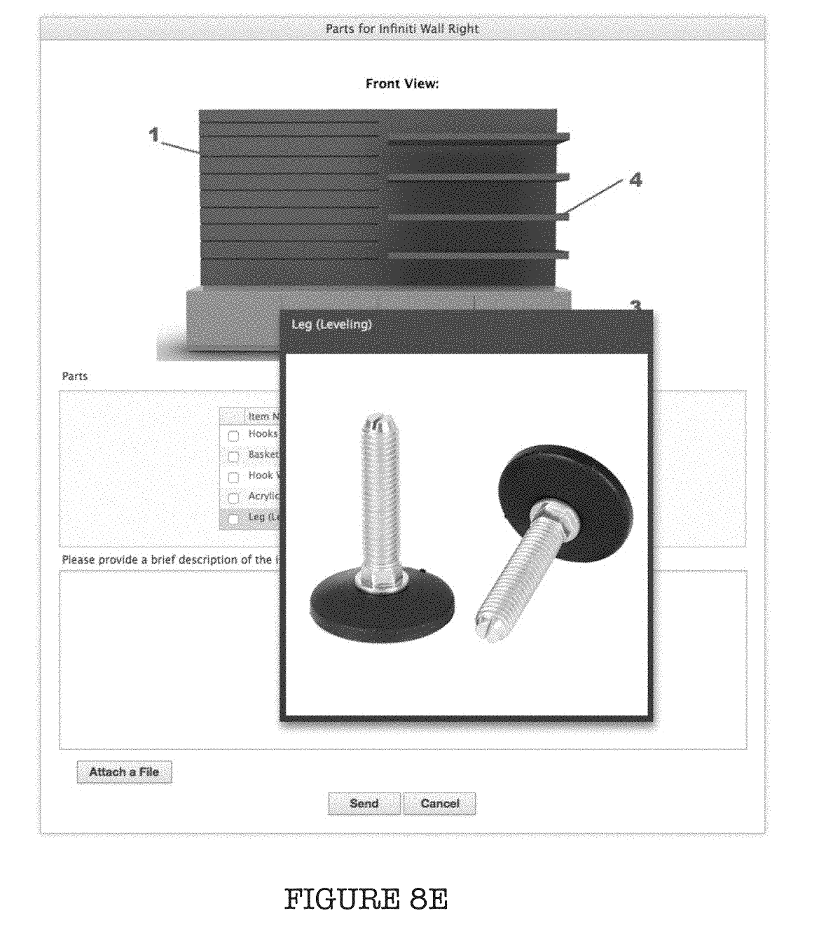

Referring to FIG. 8A, a part entry creation user interface is illustrated. This interface can also be used by way of the fixture item entry module 80. As can be seen, an image of the part can be provided by the user, along with a description of the part and details about ordering the part (e.g. a source supplier for the part, contact emails for the supplier, contact number for the supplier). Each part can then be associated with a specific fixture and the location of that part on the fixture is detailed in an image associated with the part and the fixture. In FIG. 8B, a user can thus call up a fixture and associate a part with that fixture. An image of the fixture is brought up and the user merely has to indicate where the part is located on the fixture. In the example provided, the self-leveling legs illustrated in FIG. 8A is associated with a free-standing display rack and the location of the legs is indicated on the image of the fixture by the user by way of the arrow.

In use, the user selects a fixture in need of a part from a list of fixtures from the display fixture database 110. An image of the fixture is then provided to the user to ensure that the correct fixture has been selected (see FIG. 8C). An image of the fixture with arrows indicating the location of the various parts for the fixture is then provided to the user (see FIG. 8D where only one part is indicated). The user can then view images of the various parts to see if it is the part needed for that fixture. Clicking on each part brings up an image of the part (see FIG. 8E). Once the user has located the correct part by checking the part's location on the fixture and the image of the part, the user can then initiate the ordering process for either the part or for a repair or maintenance request. The repair or maintenance request can include the condition of the part or the issue with the fixture. As in the example above, if the part is a drawer, the condition of the drawer or the issue of the drawer can be indicated in the request.

It should be noted that the ordering process for the part or for a repair or maintenance request can be passed on to the ordering module. Depending on the customer, the repair request can be forwarded to a specific company that deals with all of that customer's maintenance needs or it can be forwarded to the customer's head office for handling. Similarly, any order for supplies can also be passed on to the ordering module. A supply order, the details of which can be extracted from the user's entries, can thus be forwarded to a specific company that deals with all supplies from a specific customer. Or, based on the contact information for an item's supplier, an automated email detailing the desired supplies, the quantity of these supplies, and a desired delivery date can be generated from the order. The automated email can then be sent to the primary contact email for the supplier.

To address each order or request, whether it be a supply order, a part order, or a maintenance or repair request, a ticket-based subsystem may be used. For such a ticket based subsystem, each order or request sent to a supplier, to head office, or to another department generates a specific open ticket. These open tickets are deadline based with a specific desired completion date. Once the order or request has been granted or dealt with, the user can login to the system and close the ticket for a particular order or request. Thus, if an order for paper has been received by Store A, an authorized user in Store A can login to the system and close the ticket for that particular paper order. Similarly, a maintenance request sent to head office from Store B, once completed, can be closed by an authorized user from Store B by logging into the system. However, tickets for uncompleted orders or requests remain open and are assigned a complete-by date. If a ticket is still open by its complete-by deadline date, the ticket is automatically escalated to a higher level. As an example, if a repair request is sent to a contact at head office and is uncompleted by its deadline date, the ticket originally generated is automatically sent to another contact at head office with the other contact being higher up the corporate structure than the original contact. Thus, as an example, if the original contact for a maintenance request is a maintenance person in an organization, the follow-up ticket is escalated to the head of the maintenance department in the organization. Similarly, for supply orders, if the original contact for the supplier is a sales person, the alternate contact can be the head of sales for that supplier.

The ticket-based subsystem may be implemented by a ticket handling module that generates tickets, tracks tickets, opens and closes tickets, and automatically escalates open tickets.

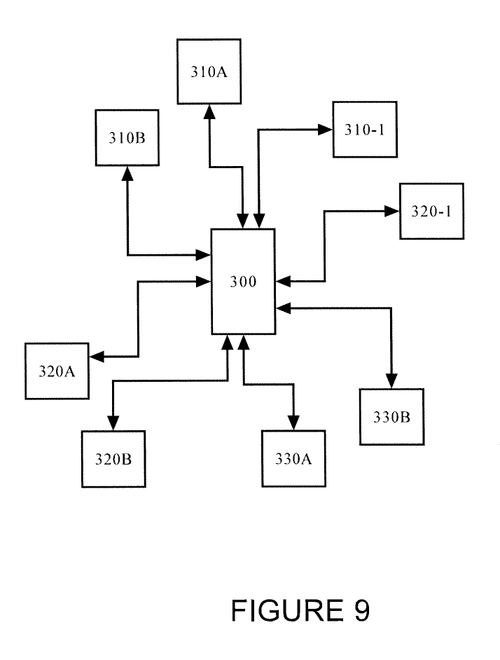

It should be noted that the system noted above can be implemented on a dedicated server system and can be provided to multiple corporate customers on a software as a service model. Referring to FIG. 9, a server 300 implements the system according to one aspect of the invention. The server 300 is accessed by users 310A, 310B from corporate customer AA. The server 300 is also accessed by users 320A, 320B from corporate customer BB. Similarly, users 330A, 330B from corporate customer CC also accesses server 300. Sales data for customer AA is accessed by server 300 and is integrated into the database 310-1 for that corporate customer. Sales data, fixtures data, and inventory data for customer BB is accessed by server 300 and these data sets are integrated by the system into the database 320-1 for customer BB. Customer CC provides inventory data to the server 300 by way of a spreadsheet and this inventory data is incorporated by the system into the database for customer CC. It should be clear that the databases for the various corporate customers are logically if not physically separate such that data for one customer is not accessible by any other customer.

The server 300 can be used to manage the display fixtures for the various stores of corporate customer AA across the country while customer CC only uses the server 300 to generate planograms for its three stores in a specific metropolitan area. The server 300 can also be used to manage customer BB's various displays and video monitors.

It should be noted that while the above description mentions different functions being executed by different modules, some functions may be bundled into a single module. As such, some functions may be executed by modules other than as described above.

It should also be noted that the functionality of the system may be spread over a number of servers or over a number of computer systems. As such, the two databases noted above may be located in different servers or they may be resident on a single server. Similarly, the two databases may be implemented as a unitary database.

For clarity, the system can be used to generate planograms, provision display fixtures, and manage the deployment, placement, configuration, and maintenance of display fixtures.

In another aspect of the invention, there is also provided a method for managing content to be displayed on video monitors or smart TVs used in stores. As noted above, current technology uses large, flat screen monitors or televisions to play loops of videos with a view to exposing the patrons of stores to the latest offerings of specific manufacturers or service providers. Current technology is both cumbersome and difficult to use as each monitor needs to be provisioned separately with a dedicated control box.

It is well-known that quite a few modern flat screen televisions are “smart” or are Internet-capable (i.e. are able to connect to the Internet and have the capabilities of a built-in web browser). This technology can be leveraged to provide a solution to the above-noted issue of provisioning videos for presentation by way of the television.

In one aspect, the present invention uses a specific web or Internet address for each smart TV in a store. Each smart TV can be remotely provisioned to play specific videos at a specific schedule. This can be accomplished by pointing the smart TV's browser function to a specific web address and by having that web address point to an automated script or code that is automatically executed by the smart TV's processor. The script causes the smart TV to download specific videos, play a list of downloaded videos at a specific schedule, and, when necessary, to refresh the video playlist. Of course, instead of downloading the videos themselves to the smart TV, the script can be configured to cause the television to merely stream videos from a specific online location based on the programmed playlist pointed to by the script. Similarly, the script can be configured to cause the television to play a single video into which multiple discrete videos have been encoded.

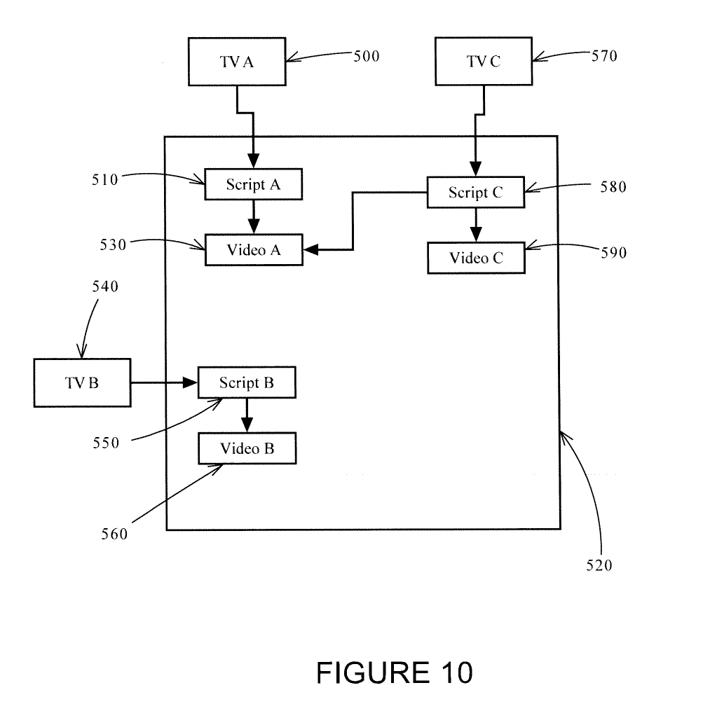

To schematically illustrate the above, FIG. 10 is provided. In FIG. 10, a first smart TV 500 is provided with a web address which points to script A 510 in server 520. Script A causes smart TV 500 to play Video A 530. Similarly, smart TV B 540 is provided with a web address which points to script B 550 in server 520. Script B causes TV B 540 to play Video B 560. TV C 570, which may be located in a location similar to TV A 500 and which is part of the same marketing campaign as TV A 500, is also provided with a web address which points to script C 580. Script C 580 causes TV C 570 to play Video A 530 as part of the same marketing campaign. However, if TV C 570 is to now be used for a different marketing campaign, script C 580 can be reconfigured to point to Video C 590. This will cause TV C 570 to now play Video C 590 instead of Video A 430.

It should be noted that the scheme outlined above allows for multiple monitors or smart TVs to play the same video even though the monitors are geographically remote from one another. Similarly, geographically adjacent monitors can be configured to play different videos from one another. Provisioning each video feed can be accomplished by simply changing the script to which specific smart TVs are pointing to. Thus, as an example, a retail chain may have smart TV displays at the back of each store as well as at the front of each store. All the smart TV displays at the back of the stores can be configured to point to a specific script that plays a specific set of videos (e.g. for one marketing campaign) while all the smart TV displays at the front of the stores can be configured to point to a specific script that plays another specific set of videos (e.g. for a different marketing campaign).

To adjust the videos played by a smart TV or by a set of smart TVs, a user merely has to upload the new videos (or select ones from videos previously uploaded), convert the videos to be included in the new playlist into a single video, select a schedule for the new playlist (i.e. when to play the videos), and adjust video or playlist pointed at by one or more scripts. Of course, the video conversion can be done automatically by the server.

The above scheme allows for fine grained control of content to be played at each and every store across a retail chain. By having a playlist for each zone in a store different marketing campaigns can be simultaneously implemented across multiple stores from a central location.

To ensure that each smart TV is playing the correct playlist, the script is configured to cause the smart TV to periodically login to the server. A check can then be made to determine if the video (or playlist) being used by the smart TV is the most current. This can be done by having the smart TV upload an encrypted token to the server. The server then checks if the token is correct and, if not, the correct token is downloaded to the smart TV. By having the token as the encrypted pointer to the video to be played, the smart TV and the server can, effectively, coordinate the current playlist. The server effectively checks the token to ensure that the file being played by the smart TV is the current one. If not, then the pointer to the current file to be played is sent to the smart TV.

To ensure that the relevant smart TVs are online (i.e. able to access the Internet), every time a smart TV logs in to the server, the server logs the time. For every smart TV, if a given period of time has elapsed and the smart TV has not logged in, the server can send an email to alert either the store or head office that a specific smart TV is off or offline. The amount of time that the server can wait for a specific smart TV to login may be configured as a multiple of the expected interval between check-in or login times for that smart TV. As an example, if each smart TV is supposed to login to the server every 10 minutes, then if a specific smart TV has not logged in after 30 minutes (i.e. the amount of time which as elapsed since the last check-in or login time for that specific smart TV is 30 minutes), then that particular smart TV is considered off or off-line. In the event a specific smart TV has gone off-line multiple times in the given time period, then the server can send an alert to head office that the smart TV may be faulty or that something unusual is occurring regarding the smart TV.

The embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g.“C”) or an object-oriented language (e.g.“C++”, “java”, “PHP”, “PYTHON” or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

What is claimed is:

1. A system for managing display fixtures, the system comprising:
a display fixture configuration module for use in configuring at least one display fixture, said display fixture configuration module being used in conjunction with an inventory database;
an item entry module for use in entering data regarding at least one item for display on said at least one display fixture, said data regarding said at least one item being for storage in said inventory database;
a display fixture management module for managing said at least one display fixture, said display fixture management module being for managing supplies and parts associated with said at least one display fixture, said display fixture management module being used in conjunction with a display fixture database; and
a fixture item entry module for use in entering data regarding at least one supply or part associated with said at least one display fixture, said data regarding said at least one supply or part being for storage in said display fixture database.

2. A system according to claim 1, wherein each supply or part associated with said at least one display fixture has an image of said supply or part for display to a user when said user is using said display fixture management module.

3. A system according to claim 1, wherein said at least one item has an image of said at least one item, said image being for display to a user when said user is using said display configuration module.

4. A system according to claim 1, wherein said data regarding said at least one supply or part associated with said at least one display fixture includes details for contacting at least one supplier of said at least one supply or part.

5. A system according to claim 4, wherein said details for contacting at least one supplier of said at least one supply or part includes at least one of:
an email address, a telephone number, a website address.

6. A system according to claim 1, wherein said display fixture management module allows a user to automatically order a quantity of said supply or part by automatically sending an email order to a supplier of said supply or part.

7. A system according to claim 6, wherein an automatically generated email for an order for said supply or part automatically generates a ticket for closing when said order has been received.

8. A system according to claim 7, wherein said ticket is escalated in the event said order is not received within a predetermined amount of time.

9. A system according to claim 8, wherein when said ticket is escalated, an automatic query is sent to another contact at said supplier of said supply or part.

10. A system according to claim 1, wherein said display fixture management module is also for managing maintenance or repairs for said at least one display fixture.

11. A system according to claim 10, wherein a request for repair or maintenance entered through said display fixture management module automatically generates a ticket for closing when said request has been fulfilled.

12. A system according to claim 11, wherein said ticket is escalated in the event said request is not fulfilled within a predetermined amount of time.

13. A system according to claim 12, wherein when said ticket is escalated, an automatic query is sent to another contact regarding said request.

14. A system according to claim 1, wherein said display configuration module displays to a user a specific item's score relative to other items.

15. A system according to claim 14, wherein said score is price based.

16. A system according to claim 14, wherein said score is sales based.

17. A system according to claim 14, wherein said score is displayed inside a representation of said specific item as said specific item is displayed on said display fixture.

18. A method for controlling content to be played on a network connected smart monitor, the method comprising:
a) receiving a network address to be accessed by said smart monitor;
b) accessing a computer executable script at said network address;
c) accessing at least one video file pointed to by said script;
d) playing said at least one video file;
e) periodically accessing a server referred to by said network address to upload an identification of said at least one video file;
f) in the event said identification is determined to be incorrect by said server, receiving a new identification of at least one video file to be played;
g) repeating steps d)-f).

19. A method according to claim 18, wherein said at least one video file comprises a video playlist.

20. A method according to claim 18, wherein said at least one video file comprises a video file containing multiple discrete video clips.

21. A method according to claim 18, wherein said at least one video file is retrieved from said server and stored prior to being played on said smart monitor.

22. A method according to claim 18, wherein said at least one video file is streamed from said server for playback by said smart monitor.

23. A method according to claim 18, wherein said network address is a URL for said script.

24. A method according to claim 18, wherein said script is for simultaneous use by multiple smart monitors.
